(19) United States
(12) Patent Application Publication
(10) Pub. No.: US 2025/0209622 A1
(43) Pub. Date: Jun. 26, 2025

(54) EXPRESSION-LEVEL PREDICTION FOR BIOMARKERS IN DIGITAL PATHOLOGY IMAGES

(71) Applicant: Ventana Medical Systems, Inc., Tucson, AZ (US)

(72) Inventors: Jim F. Martin, Mountain View, CA (US); Yao Nie, Sunnyvale, CA (US); Raghavan Venugopal, Fremont, CA (US); Xingwei Wang, Sunnyvale, CA (US)

(73) Assignee: Ventana Medical Systems, Inc., Tucson, AZ (US)

(21) Appl. No.: 19/076,883

(22) Filed: Mar. 11, 2025

Related U.S. Application Data
(63) Continuation of application No. PCT/US2023/034540, filed on Oct. 5, 2023.
(60) Provisional application No. 63/414,751, filed on Oct. 10, 2022.

(51) Int. Cl. G06T 7/00; G06V 10/20; G06V 10/766; G06V 10/77; G06V 20/69

(52) U.S. Cl. CPC G06T 7/0012; G06V 10/20; G06V 10/766; G06V 10/7715; G06V 20/695; G06T 2207/10056; G06T 2207/20081; G06T 2207/20084; G06T 2207/30024; G06T 2207/30096; G06T 2207/30204; G06V 2201/03

(57) ABSTRACT

Embodiments disclosed herein generally relate to expression-level prediction for digital pathology images. Particularly, aspects of the present disclosure are directed to accessing a duplex immunohistochemistry image of a slice of specimen, wherein the duplex immunohistochemistry image comprises a depiction of cells associated with a first biomarker and/or a second biomarker corresponding to a disease; generating, from the duplex immunohistochemistry image, a first synthetic image depicting the first biomarker and a second synthetic image depicting the second biomarker; determining a set of features representing pixel intensities of the depiction of cells in the first synthetic image and the second synthetic image; processing the set of features using a trained machine learning model; and outputting a result that corresponds to a predicted characterization of the specimen with respect to the disease based on an output of the processing corresponding to a predicted expression level of the first biomarker and the second biomarker.

### CROSS REFERENCE TO RELATED APPLICATIONS

This application is a continuation of International Patent Application No. PCT/US2023/034540, filed on Oct. 5, 2023, which claims priority to U.S. Provisional Patent Application No. 63/414,751, filed on Oct. 10, 2022, titled “EXPRESSION-LEVEL PREDICTION FOR BIOMARKERS IN DIGITAL PATHOLOGY IMAGES”. Each of these applications is hereby incorporated by reference in its entirety for all purposes.

### BACKGROUND

Digital pathology involves scanning slides of samples (e.g., tissue samples, blood samples, urine samples, etc.) into digital images. The sample can be stained such that select proteins (antigens) in cells are differentially visually marked relative to the rest of the sample. The target protein in the specimen may be referred to as a biomarker. Digital images with one or more stains for biomarkers can be generated for a tissue sample. These digital images may be referred to as histopathological images. Histopathological images can allow visualization of the spatial relationship between tumorous and non-tumorous cells in a tissue sample. Image analysis may be performed to identify and quantify the biomarkers in the tissue sample. The image analysis can be performed by pathologists to facilitate characterization of the biomarkers (e.g., in terms of expression level, presence, size, shape and/or location) so as to inform (for example) diagnosis of a disease, determination of a treatment plan, or assessment of a response to a therapy. However, analysis performed by pathologists may be subjective and inaccurate for scoring an expression level of biomarkers in an image.

### SUMMARY

Embodiments of the present disclosure relate to techniques for predicting expression levels of biomarkers in digital pathology images. In some embodiments, a computer-implemented method involves accessing a duplex immunohistochemistry (IHC) image of a slice of specimen. The duplex IHC image includes a depiction of cells associated with one or more of a first biomarker and a second biomarker corresponding to a disease. The computer-implemented method further involves generating, from the duplex IHC image, a first synthetic image depicting the first biomarker and a second synthetic image depicting the second biomarker and determining, for each of the first synthetic image and the second synthetic image, a set of features representing pixel intensities of the depiction of cells in the first synthetic image and the second synthetic image. The computer-implemented method also involves processing the set of features using a trained machine learning model. An output of the processing corresponds to a predicted expression level of the first biomarker and the second biomarker. In addition, the computer-implemented method involves outputting a result that corresponds to a predicted characterization of the specimen with respect to the disease based on the output of the processing.

In some embodiments, the computer-implemented method further involves, prior to determining the set of features, preprocessing the first synthetic image and the second synthetic image by applying color deconvolution to the first synthetic image and the second synthetic image.

In some embodiments, the computer-implemented method further involves, prior to determining the set of features, processing the first synthetic image and the second synthetic image using another trained machine learning model. Another output of the processing identifies first depictions of cells of the first synthetic image predicted to depict the first biomarker and second depictions of cells of the second synthetic image predicted to depict the second biomarker.

In some embodiments, determining the set of features for the first synthetic image involves determining, for each cell in the first depictions of cells, a first metric associated with an intensity value for a patch of the cell including the cell, aggregating, for the first depictions of cells, the first metric for each patch, and determining, based on the aggregation, a plurality of intensity values for the first depictions of cells. Each intensity value of the plurality of intensity values corresponds to an intensity percentile, and the plurality of intensity values correspond to the set of features.

In some embodiments, determining the set of features for the first synthetic image involves determining, for each cell in the first depictions of cells, a first plurality of intensity values corresponding to intensity percentiles for a patch including the cell, aggregating, for the first depictions of cells, the first plurality of intensity values for each patch to generate a second plurality of intensity values, and determining a set of metrics associated with a distribution of the second plurality of intensity values. The set of metrics correspond to the set of features.

In some embodiments, the first biomarker includes estrogen receptor proteins and the second biomarker includes progesterone receptor proteins.

In some embodiments, the trained machine learning model is a linear regression model.

In some embodiments, a sample slice of the specimen comprises a first stain for the first biomarker and a second stain for the second biomarker.

In some embodiments, the first stain comprises tetramethylrhodamine and the second stain comprises 4-Dimethylaminoazobenzene-4′-sulfonyl.

In some embodiments, the computer-implemented method further involves performing subsequent processing to generate the result of the predicted characterization of the specimen. Performing the subsequent processing includes detecting depictions of a set of tumor cells. The result characterizes a presence of, quantity of and/or size of the set of tumor cells.

In some embodiments, a system includes one or more data processors and a non-transitory computer readable storage medium containing instructions which, when executed on the one or more data processors, cause the one or more data processors to perform operations. The operations include accessing a duplex IHC image of a slice of specimen. The duplex IHC image includes a depiction of cells associated with one or more of a first biomarker and a second biomarker corresponding to a disease. The operations further include generating, from the duplex IHC image, a first synthetic image depicting the first biomarker and a second synthetic image depicting the second biomarker and determining, for each of the first synthetic image and the second synthetic image, a set of features representing pixel intensities of the depiction of cells in the first synthetic image and the second synthetic image. The operations also involve processing the set of features using a trained machine learning model. An output of the processing corresponds to a predicted expression level of the first biomarker and the second biomarker. In addition, the operations include outputting a result that corresponds to a predicted characterization of the specimen with respect to the disease based on the output of the processing.

In some embodiments, a computer-program product tangibly embodied in a non-transitory machine-readable storage medium, includes instructions configured to cause one or more data processors to perform operations. The operations include accessing a duplex IHC image of a slice of specimen. The duplex IHC image includes a depiction of cells associated with one or more of a first biomarker and a second biomarker corresponding to a disease. The operations further include generating, from the duplex IHC image, a first synthetic image depicting the first biomarker and a second synthetic image depicting the second biomarker and determining, for each of the first synthetic image and the second synthetic image, a set of features representing pixel intensities of the depiction of cells in the first synthetic image and the second synthetic image. The operations also involve processing the set of features using a trained machine learning model. An output of the processing corresponds to a predicted expression level of the first biomarker and the second biomarker. In addition, the operations include outputting a result that corresponds to a predicted characterization of the specimen with respect to the disease based on the output of the processing.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTIONS OF THE DRAWINGS

The patent or application file contains at least one drawing executed in color. Copies of this patent or patent application publication with color drawing(s) will be provided by the Office upon request and payment of the necessary fec.

Aspects and features of the various embodiments will be more apparent by describing examples with reference to the accompanying drawings, in which:

FIG. 1 shows an exemplary computing system for training and using a machine-learning model for expression-level prediction;

FIG. 2 illustrates an example duplex immunohistochemistry image of a slice of specimen stained for estrogen receptor proteins and progesterone receptor proteins;

FIG. 3 illustrates synthetic images generated from a duplex immunohistochemistry image of a slice of specimen stained for estrogen receptor proteins and progesterone receptor proteins;

FIG. 4 illustrates examples of intensity-synthetic images generated by applying color deconvolution to duplex immunohistochemistry images;

FIG. 5 illustrates an example of an output of a trained machine learning model for predicting biomarker depictions;

FIG. 6 illustrates an image of cells predicted to depict positive staining for a biomarker overlaid on an intensity-synthetic image for the biomarker;

FIG. 7 illustrates images of predicted biomarker depictions and extracted patches;

FIG. 8 illustrates example tables of intensity values for intensity percentiles for each of a weak staining image and a moderate-to-high staining image for estrogen receptor proteins;

FIG. 9 illustrates example histograms corresponding to a weak staining image and a moderate-to-high staining image for an estrogen receptor protein;

FIG. 10 illustrates example histograms corresponding to a weak staining image and a moderate-to-high staining image for a progesterone receptor protein;

FIG. 11 illustrates additional example histograms corresponding to a weak staining image and a moderate-to-high staining image for an estrogen receptor protein;

FIG. 12 illustrates additional example histograms corresponding to a weak staining image and a moderate-to-high staining image for a progesterone receptor protein;

FIG. 13 illustrates an exemplary process of expression-level prediction for digital pathology images;

FIG. 14 illustrates example expression levels of Dabsyl estrogen receptor proteins determined by three pathologists for 50 fields of view;

FIG. 15 illustrates example expression levels of Tamra progesterone receptor proteins determined by three pathologists for 50 fields of view;

FIG. 16 illustrates example performances of using a machine learning model to predict expression level; and

FIG. 17 illustrates exemplary expression-level scores generated by pathologists and a trained machine learning model.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### I. Overview

The present disclosure describes techniques for predicting expression levels of biomarkers in digital pathology images. More specifically, some embodiments of the present disclosure provide processing duplex immunohistochemistry (IHC) images by machine-learning models trained for expression-level prediction.

Digital pathology may involve the interpretation of digitized pathology images in order to correctly diagnose subjects and guide therapeutic decision making. In digital pathology solutions, image-analysis workflows can be established to automatically detect or classify biological objects of interest e.g., positive, negative tumor cells, etc. An exemplary digital pathology solution workflow includes obtaining tissue slides, scanning preselected areas or the entirety of the tissue slides with a digital image scanner to obtain digital images, performing image analysis on the digital image using one or more image analysis algorithms, and potentially detecting, quantifying (e.g., counting or identify object-specific or cumulative areas of) each object of interest based on the image analysis (e.g., quantitative or semi-quantitative scoring such as positive, negative, medium, weak, etc.).

During imaging and analysis, regions of a digital pathology image may be segmented into target regions (e.g., positive and negative tumor cells) and non-target regions (e.g., normal tissue or blank slide regions). Each target region can include a region of interest that may be characterized and/or quantified. Machine-learning models can be developed to segment the target regions. A pathologist may then score the expression level of a biomarker in the segments. But, pathologist scores may be subjective and having multiple pathologists score each segment can be time and resource intensive.

In some embodiments, a trained machine learning model determines predictions of the expression level of biomarkers in a digital pathology image. A higher expression level may correspond to a higher likelihood of a presence of a disease. The digital pathology image may be a duplex IHC image of a slice of specimen stained for two biomarkers. A synthetic image can be generated for each biomarker (e.g., by applying color deconvolution to the duplex IHC image). Then, a set of features representing pixel intensities in the synthetic images can be determined for each synthetic image. In some examples, the set of features may be extracted from synthetic images that have been further processed into grayscale images with pixel values representing the intensity. The set of features may be, for each of multiple intensity percentiles, a single intensity value that corresponds to the intensity percentile. Or, the set of features may be a set of metrics corresponding to a distribution of intensity values for each intensity percentile. In either case, the trained machine learning model can process the set of features to generate an output that corresponds to a predicted expression level of the first biomarker and the second biomarker. Based on the predicted expression levels, a characterization of the specimen with respect to a disease may be determined. For example, the characterization may be a diagnosis of the disease, a prognosis of the disease, or a predicted treatment response of the disease.

Using features that represent pixel intensities as an input to the trained machine learning model may result in expression-level predictions that accurately correlate with pathologist scoring. So, the trained machine learning model may provide accurate and faster expression level predictions. Thus, the predictions made by the trained machine learning model can result in more efficient and better diagnosis and treatment assessment of diseases (e.g., cancer and/or an infectious disease).

### II. Computing Environment

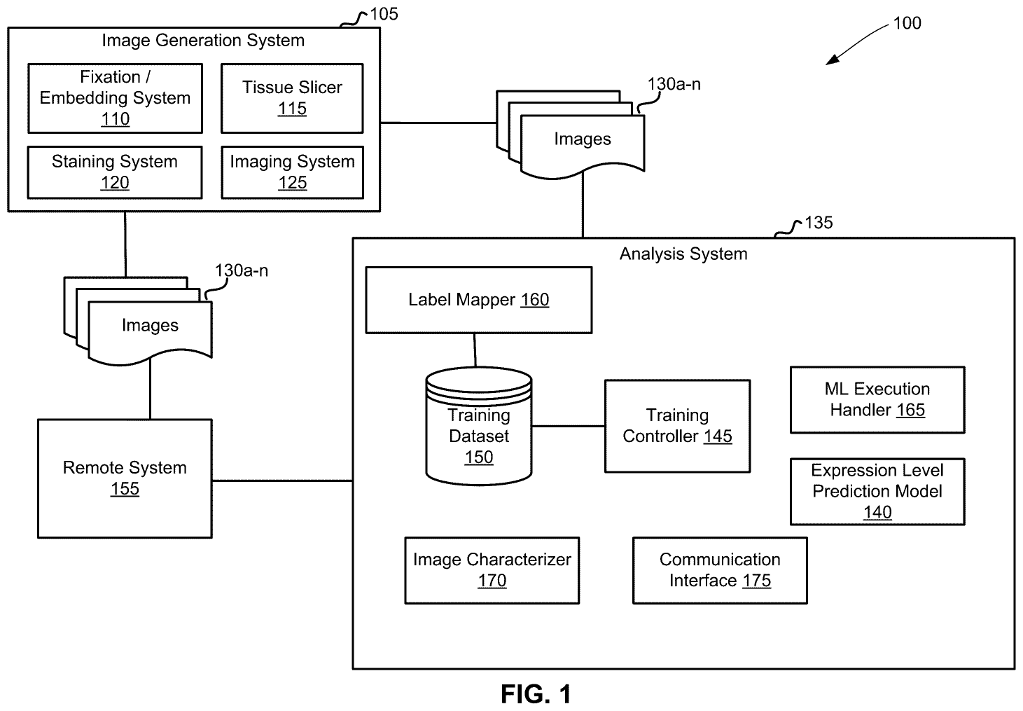

FIG. 1 shows an exemplary computing system 100 for training and using a machine-learning model for expression-level prediction. Images are generated at an image generation system 105. The images may be digital pathology images, such as duplex IHC images. A fixation/embedding system 110 fixes and/or embeds a tissue sample (e.g., a sample including at least part of at least one tumor) using a fixation agent (e.g., a liquid fixing agent, such as a formaldehyde solution) and/or an embedding substance (e.g., a histological wax, such as a paraffin wax and/or one or more resins, such as styrene or polyethylene). Each slice may be fixed by exposing the slice to a fixating agent for a predefined period of time (e.g., at least 3 hours) and by then dehydrating the slice (e.g., via exposure to an ethanol solution and/or a clearing intermediate agent). The embedding substance can infiltrate the slice when it is in liquid state (e.g., when heated).

A tissue slicer 115 then slices the fixed and/or embedded tissue sample (e.g., a sample of a tumor) to obtain a series of sections, with each section having a thickness of, for example, 4-5 microns. Such sectioning can be performed by first chilling the sample and the slicing the sample in a warm water bath. The tissue can be sliced using (for example) using a vibratome or compresstome.

Because the tissue sections and the cells within them are virtually transparent, preparation of the slides typically includes staining (e.g., automatically staining) the tissue sections in order to render relevant structures more visible. In some instances, the staining is performed manually. In some instances, the staining is performed semi-automatically or automatically using a staining system 120.

The staining can include exposing an individual section of the tissue to one or more different stains (e.g., consecutively or concurrently) to express different characteristics of the tissue. For example, each section may be exposed to a predefined volume of a staining agent for a predefined period of time. A duplex assay includes an approach where a slide is stained with two biomarker stains. A singleplex assay includes an approach where a slide is stained with a single biomarker stain. A multiplex assay includes an approach where a slide is stained with two or more biomarker stains.

One exemplary type of tissue staining is histochemical staining, which uses one or more chemical dyes (e.g., acidic dyes, basic dyes) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is hematoxylin and cosin (H&E). Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is immunohistochemistry (IHC, also called “immunostaining”), which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

The sections may be then be individually mounted on corresponding slides, which an imaging system 125 can then scan or image to generate raw digital-pathology, or histopathological, images. The histopathological images may be included in images 130a-n. Each section may be mounted on a slide, which is then scanned to create a digital image that may be subsequently examined by digital pathology image analysis and/or interpreted by a human pathologist (e.g., using image viewer software). The pathologist may review and manually annotate the digital image of the slides (e.g., expression level, tumor area, necrosis, etc.) to enable the use of image analysis algorithms to extract meaningful quantitative measures (e.g., to detect and classify biological objects of interest). Conventionally, the pathologist may manually annotate each successive image of multiple tissue sections from a tissue sample to identify the same aspects on each successive tissue section.

The computing system 100 can include an analysis system 135 to train and execute a machine-learning model. Examples of the machine-learning model can be a deep convolutional neural network, a U-Net, a V-Net, a residual neural network, a recurrent neural network, a linear regression model, a logistic regression model, or a support vector machine. The machine-learning model may be an expression level prediction model 140 trained and/or used to (for example) predict an expression level of biomarkers in an image. The expression level of the biomarkers may correspond to a diagnosis or treatment decisions related to a disease (e.g., a certain expression level is associated with a predicted positive diagnosis or treatment action). So, additional processing can be performed on the image based on the predicted expression level to further predict whether the image includes a depiction of a set of tumor cells or other structural and/or functional biological entities associated with a disease, whether the image is associated with a diagnosis of the disease, whether the image is associated with a classification (e.g., stage, subtype, etc.) of the disease, and/or the image is associated with a prognosis for the disease. The prediction may characterize a presence of, quantity of and/or size of the set of tumor cells or the other structural and/or functional biological entities, the diagnosis of the disease, the classification of the disease, and/or the prognosis of the disease.

The analysis system 135 may additional train and execute another machine-learning model for predicting depictions of one or more positive-staining biomarkers in an image. Examples of the other machine-learning model can be a deep convolutional neural network, a U-Net, a V-Net, a residual neural network, a recurrent neural network, a linear regression model, a logistic regression model, or a support vector machine. The other machine learning model may predict positive and negative staining of depictions of biomarkers for cells in an image (e.g., duplex image or singleplex image). Expression-level prediction may only be performed in association with cells having a positive prediction of at least one biomarker, so an output of the other machine-learning model can be used to determine on which portions of images expression-level prediction is to be performed.

A training controller 145 can execute code to train the expression level prediction model 140 and/or the other machine-learning model(s) using one or more training datasets 150. Each training dataset 150 can include a set of training images from images 130a-n. Each of the images may include a duplex IHC image stained for depicting two biomarkers or singleplex IHC images stained for depicting one of two biomarkers and one or more biological objects (e.g., a set of cells of one or more types). Each image in a first subset of the set of training images may include one or more biomarkers, and each image in a second subset of the set of training images may lack biomarkers. Each of the images may depict a portion of a sample, such as a tissue sample (e.g., colorectal, bladder, breast, pancreas, lung, or gastric tissue), a blood sample or a urine sample. In some instances, each of one or more of the images depicts a plurality of tumor cells or a plurality of other structural and/or functional biological entities. The training dataset 150 may have been collected (for example) from the image generation system 105.

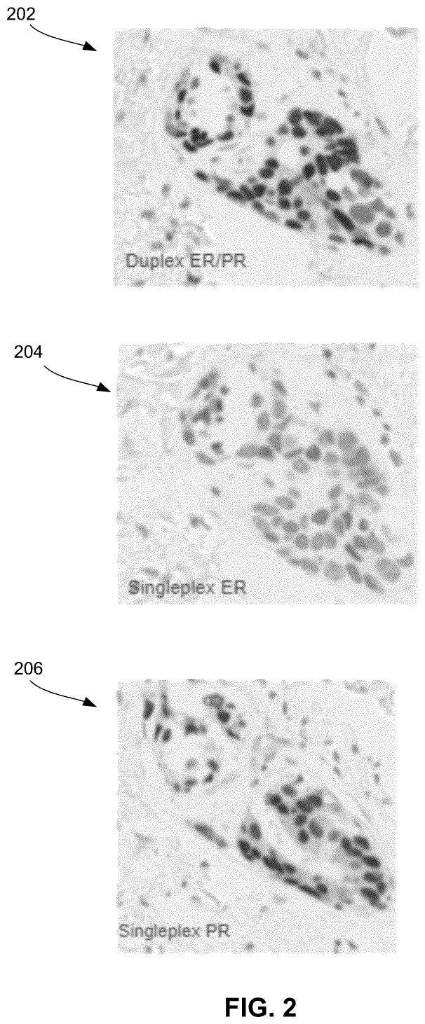

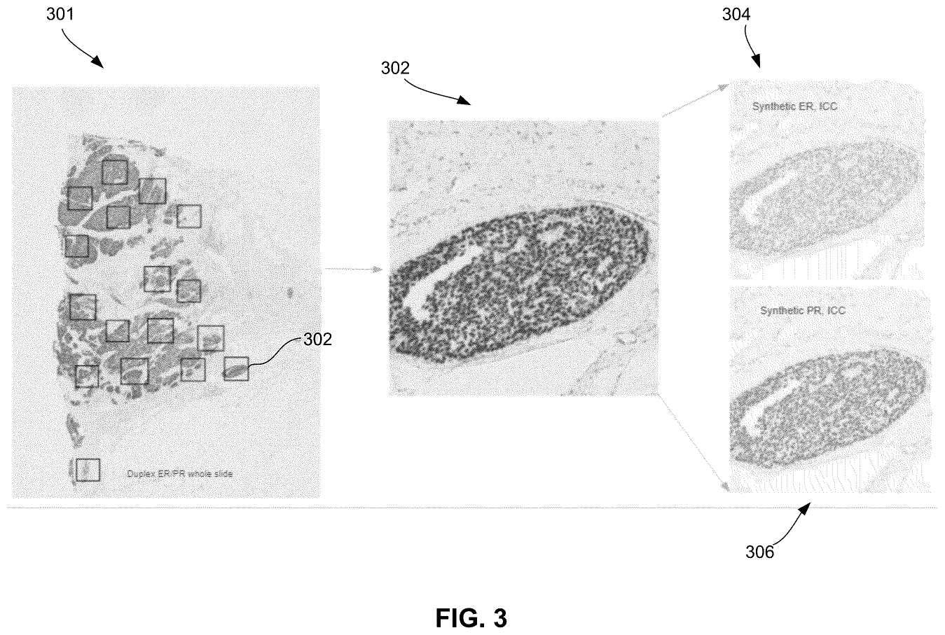

In some instances, the training controller 145 determines or learns preprocessing parameters and/or approaches. For example, preprocessing can include generating synthetic images from a duplex IHC image, where each synthetic image depicts one of the two biomarkers in the duplex IHC image. The duplex IHC image may (for example) be an image of a slice of specimen stained with a first stain (e.g., tetramethylrhodamine (Tamra)) associated with a first biomarker (e.g., progesterone receptor proteins) and a second stain (e.g., 4-Dimethylaminoazobenzene-4′-sulfonyl (Dabsyl)) associated with a second biomarker (e.g., estrogen receptor proteins). In addition, the slice of specimen may include a counterstain (e.g., hematoxylin). Color deconvolution may be applied to generate the synthetic images for each biomarker. That is, a first color vector can be applied to the duplex IHC image to generate a first synthetic image depicting the first biomarker based on the color of the first stain and a second color vector can be applied to the duplex IHC image to generate a second synthetic image depicting the second biomarker based on the color of the second stain. FIGS. 2 and 3 illustrate examples of duplex IHC images 202/302 of slices of specimen stained for estrogen receptor proteins and progesterone receptor proteins. In FIG. 3, the duplex IHC image 302 is a portion of a whole slide image 301. Color deconvolution is performed for the duplex IHC images 202/302 to generate synthetic images 204/206/304/306. Synthetic images 304/404 each depict the estrogen receptor proteins, whereas the synthetic images 206/306 depict the progesterone receptor proteins.

Color deconvolution may additionally be applied to each of the synthetic images to generate images representing intensity (e.g., grayscale images with pixel values between 0 and 255 representing intensity). The color deconvolution can involve determining stain reference vectors from the synthetic images or no-counterstain images, performing matrix inversion using the reference vectors to determine contributions of each stain to that pixel optical density or intensity, and generating the intensity synthetic singleplex images by recombining the unmixed images.

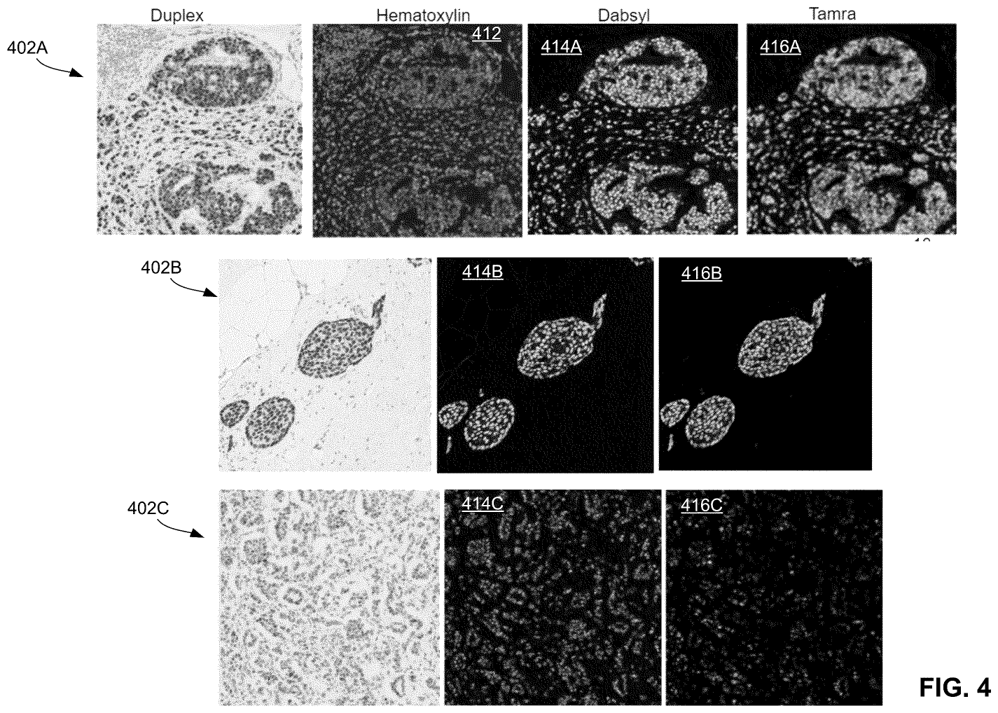

FIG. 4 illustrates examples of intensity-synthetic images generated by applying color deconvolution to duplex IHC images. For instance, image 412 represents a hematoxylin intensity, image 414A represents a Dabsyl estrogen receptor intensity, and image 416A represents a Tamra progesterone receptor intensity for duplex IHC image 402A. In addition, images 414B-C represent Dabsyl estrogen receptor intensities, and images 416B-C represent Tamra progesterone receptor intensities for duplex IHC image 402B-C, respectively. Duplex IHC image 402B can correspond to moderate-to-high staining, whereas duplex IHC image 402C can correspond to a weak staining.

Returning to FIG. 1, the training controller 145 can feed the original or preprocessed images (e.g., the duplex IHC image and/or each of the synthetic images) into the other trained machine learning model having an architecture (e.g., U-Net) used during previous training and configured with learned parameters. The other trained machine learning model can generate an output identifying first depictions of cells predicted to depict a positive staining of a first biomarker and second depictions of cells predicted to depict a positive staining of a second biomarker.

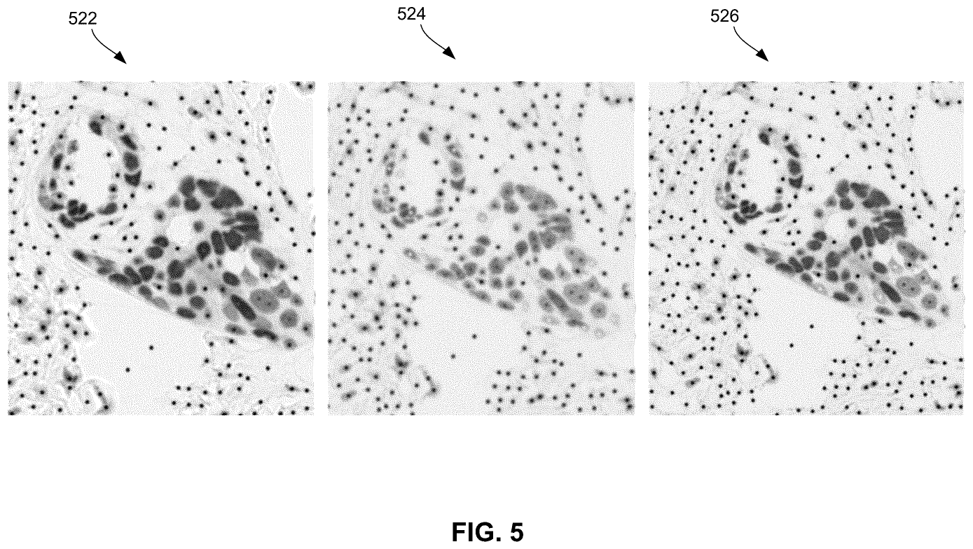

Referring to FIG. 5, an output of the other trained machine learning model is shown. Image 522 illustrates a duplex IHC image with predicted biomarker depictions of various colors. For example, cells depicted as red correspond to positive staining for both biomarkers, cells depicted as green correspond to positive staining for the first biomarker (e.g., estrogen receptor proteins), cells depicted in blue correspond to positive staining for the second biomarker (e.g., progesterone receptor proteins), cells depicted in yellow correspond to negative staining for both biomarkers, and cells depicted in black correspond to other detected cells (e.g., stoma cells). Synthetic images may additionally be input to the trained machine learning model to generate images 524/526, or, the predicted biomarker depictions may be extracted from image 522 and overlaid on the synthetic images to generate images 524/526. In image 524, which corresponds to a synthetic image depicting the estrogen receptor proteins, cells depicted in red correspond to positive staining for estrogen receptor proteins, cells depicted in yellow correspond to negative staining for estrogen receptor proteins, and cells depicted in black correspond to other detected cells. In image 526, which corresponds to a synthetic image depicting the progesterone receptor proteins, cells depicted in red correspond to positive staining for progesterone receptor proteins, cells depicted in yellow correspond to negative staining for progesterone receptor proteins, and cells depicted in black correspond to other detected cells.

Returning to FIG. 1, once the other trained machine learning model outputs the predicted biomarker depictions, the training controller 145 may generate an input for the expression level prediction model 140. Expression-level prediction may only be performed on cells predicted to depict positive staining for at least one of the biomarkers. So, based on the output of the other trained machine learning model, portions of the duplex IHC image and/or the synthetic images that depict positive staining for one or more of the biomarkers can be extracted. For example, in the intensity-synthetic image for the first biomarker, portions predicted to depict positive staining for the first biomarker can be extracted. In addition, in the intensity-synthetic image for the second biomarker, portions predicted to depict positive staining for the second biomarker can be extracted. Extracting the portions can involve defining a patch (e.g., a 5×5 patch) around each portion predicted to include a positive-staining cell.

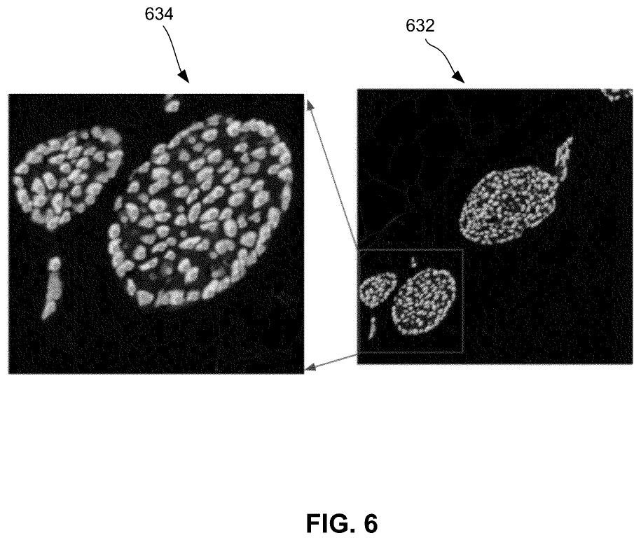

Referring to FIG. 6, an image 632 of cells predicted to depict positive staining for a biomarker overlaid on an intensity-synthetic image for the biomarker is illustrated. A patch 634 is extracted from the image 632. The patch 634 is a 5×5 patch of a portion of the image 632 predicted to depict a cell with positive staining for the biomarker. Multiple patches can be extracted from the image 632, and each patch can be a 5×5 patch surrounding a cell predicted to depict positive staining for the biomarker.

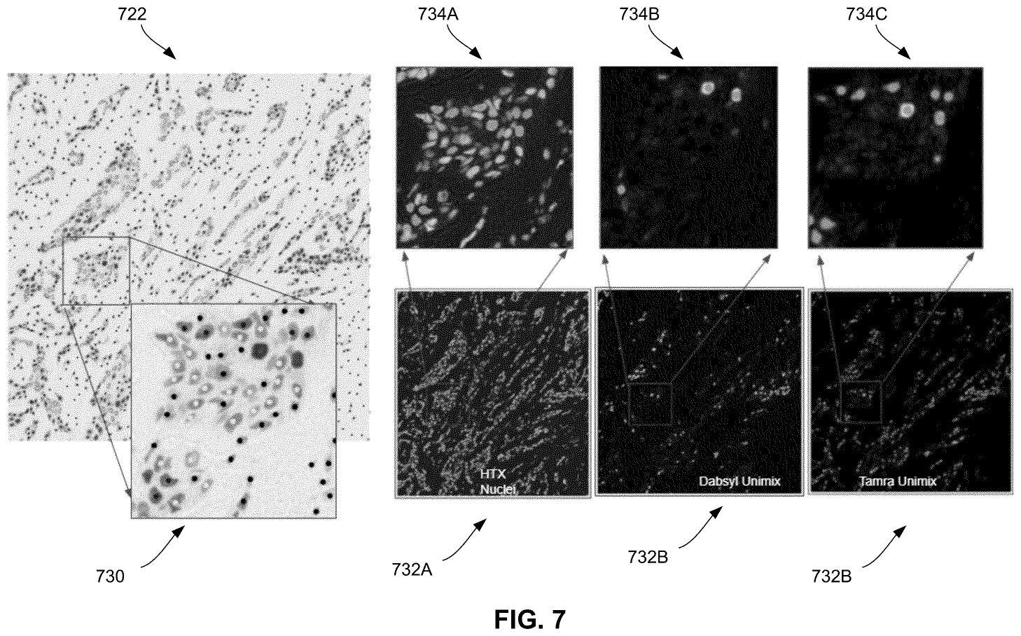

Similarly, FIG. 7 illustrates an image 722 with predicted biomarker depictions and an extracted patch 730. Intensity-synthetic images 732A-C illustrate the depictions of cells predicted to include positive staining for biomarkers in the image 722 and patches 734A-C illustrate the depictions of cells predicted to include positive staining for biomarkers in the patch 730. Image 732A and patch 734A illustrate depicted cells predicted to include positive staining for both estrogen receptor proteins and progesterone receptor proteins. Image 732B and patch 734B illustrate depicted cells predicted to include positive staining in the Dabsyl channel, where only the cell patches around cells predicted to include positive staining for the estrogen receptor proteins are calculated, and positive staining progesterone receptor cells are not considered to calculate the expression level. Image 732C and patch 734C illustrate depicted cells predicted to include positive staining in the Tamra channel, where only the cell patches around cells predicted to include positive staining for the progesterone receptor proteins are calculated, and positive staining estrogen receptor cells are not considered to calculate the expression level.

Returning to FIG. 1, in an example, the training controller 145 can perform feature extraction for each patch to generate a set of features representing pixel intensities of the depiction of cells in the first synthetic image and the second synthetic image. In a first feature extraction technique, the training controller 145 can determine, for each cell in the intensity-synthetic image predicted to depict positive staining for the first biomarker, a metric associated with an intensity value for the patch including the cell. For example, the metric may be an average intensity value of the pixels in the patch. The training controller 145 can then aggregate the metric for each patch in the intensity-synthetic image. Aggregating the metrics may involve ranking the average values for each patch from least intense (e.g., closer to 0) to most intense (e.g., closer to 255). The metrics may additionally be normalized so that each value is between 0 and 1. From the aggregated metrics, the training controller 145 can determine intensity values for the cells in the intensity-synthetic image predicted to depict positive staining for the first biomarker. Each intensity value can correspond to an intensity percentile from the normalized patch intensities. The training controller 145 can perform a similar process for each cell in the intensity-synthetic image predicted to depict positive staining for the second biomarker.

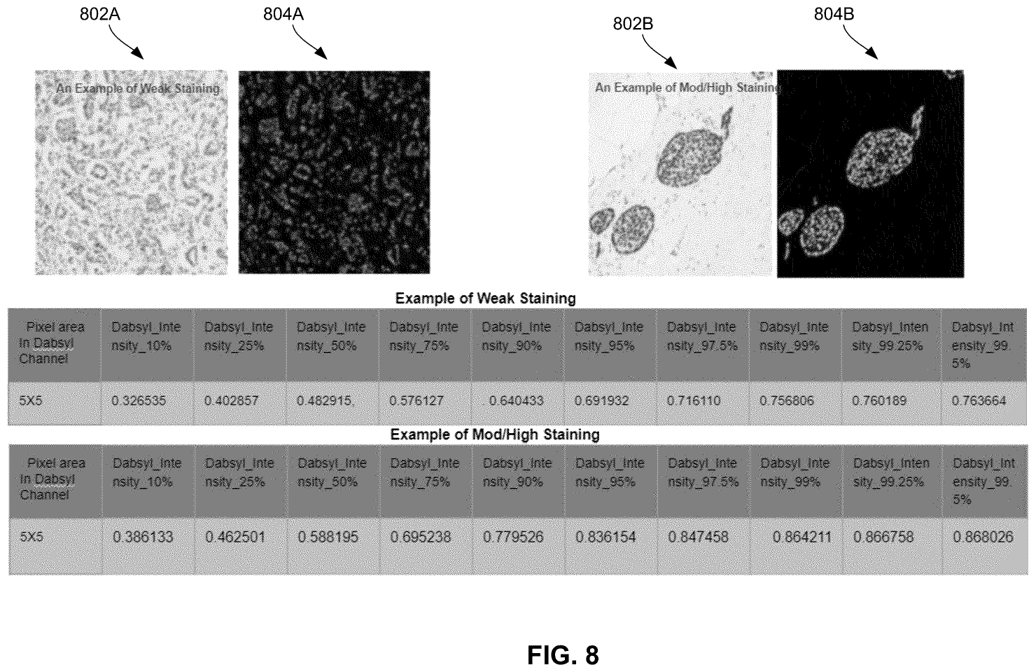

Turning to FIG. 8, example tables of intensity values for intensity percentiles for each of a weak staining image 802A and a moderate-to-high staining image 802B for estrogen receptor proteins are illustrated. Images 804A-B are intensity-synthetic images corresponding to the weak staining image 802A and the moderate-to-high staining image 802B, respectively. The intensity values are the aggregated normalized intensity values for each of the images 804A-B. For each of the images 804A-B, the aggregated normalized intensity value for the 10% intensity percentile, 25% intensity percentile, the 50% intensity percentile, 90% intensity percentile, 95% intensity percentile, 97.5% intensity percentile, 99% intensity percentile, 99.25% intensity percentile, and the 99.5% intensity percentile are illustrated. For the image 804A, the aggregated normalized intensity value for the 10% intensity percentile is 0.326535, increases at each intensity percentile, and is 0.763664 for the 99.5% intensity percentile. In contrast, for the image 804B, the aggregated normalized intensity value for the 10% intensity percentile is 0.386133, increases at each intensity percentile, and is 0.868026 for the 99.5% intensity percentile. At each intensity percentile, the intensity value is greater for the moderate-to-high staining image 802B than for the weak staining image 802A.

Returning to FIG. 1, an alternate feature extraction technique may involve the training controller 145 determining, for each patch in the intensity-synthetic image predicted to depict positive staining for the first biomarker, intensity values that correspond to intensity percentiles (e.g., 50%, 60%, 70%, 80%, 90%, and 95%) for the patch. So, for a given patch, the training controller 145 can determine a distribution of intensity values in the patch. Based on the distribution, the training controller 145 can determine an intensity value associated with each intensity percentile. Then the training controller 145 can aggregate the intensity values for the intensity percentiles for each patch in the intensity-synthetic image. That is, the intensity values associated with the 50% percentile for each patch can be aggregated, the intensity values associated with the 60% percentile can be aggregated, etc. The training controller 145 can then compute histograms for each intensity percentile and normalize the bins for each histogram.

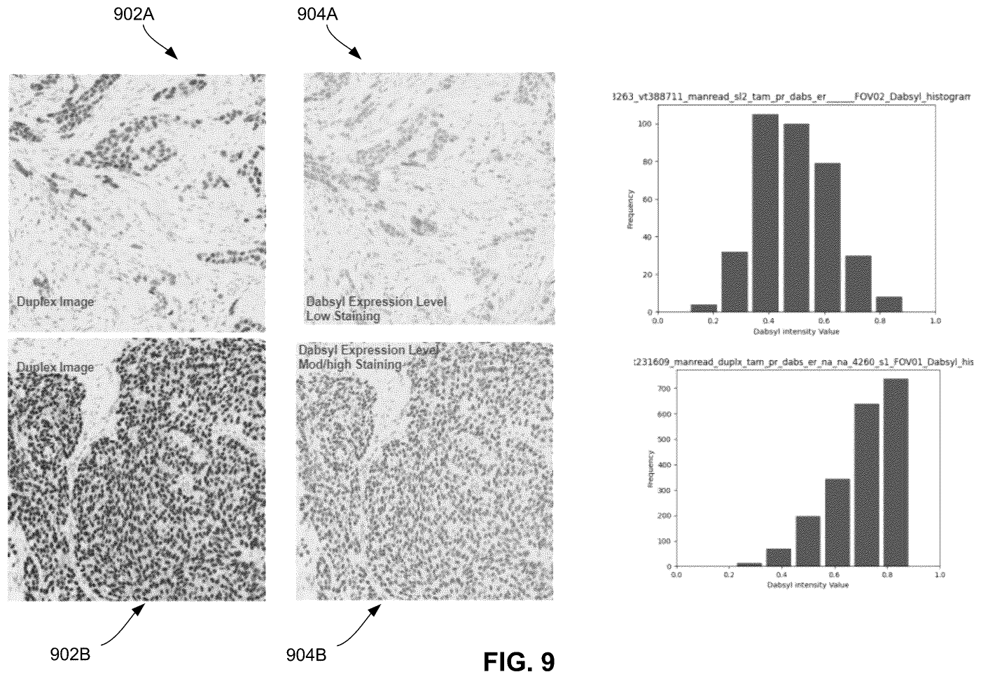

Turning to FIG. 9, examples of histograms corresponding to a weak staining image 904A and a moderate-to-high staining image 904B for an estrogen receptor protein are illustrated. The weak staining image 904A is generated from a duplex IHC image 902A and the moderate-to-high staining image 904B is generated from a duplex image 902B. For the weak staining image, a majority of the intensity values are between 0.3 and 0.7, and for the moderate-to-high staining image, a majority of the intensity values are between 0.6 and 0.9.

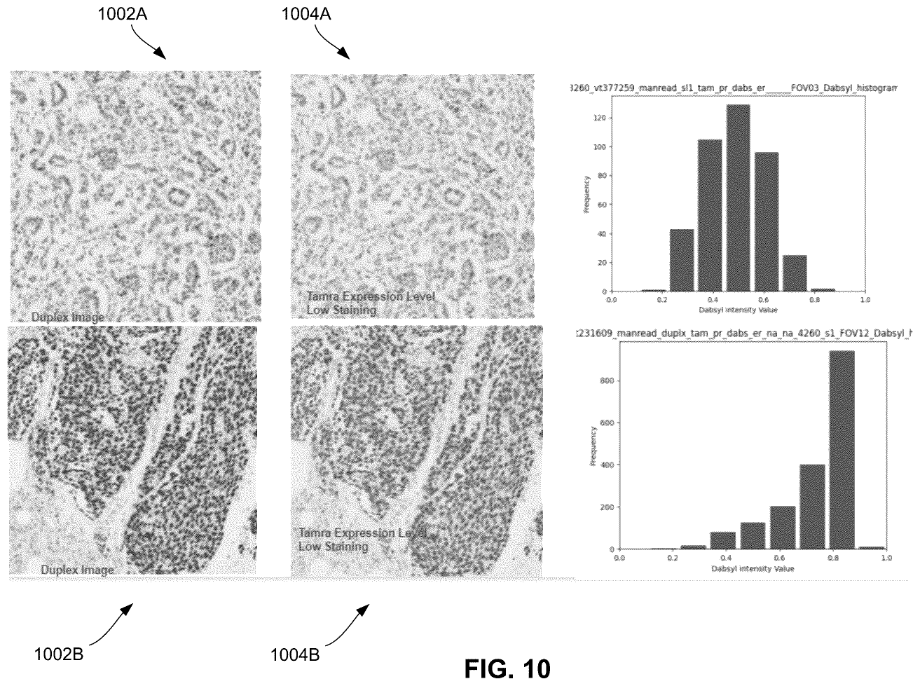

FIG. 10 illustrates example histograms corresponding to a weak staining image 1004A and a moderate-to-high staining image 1004B for a progesterone receptor protein. The weak staining image 1004A is generated from a duplex IHC image 1002A and the moderate-to-high staining image 1004B is generated from a duplex image 1002B. For the weak staining image 1004A, a majority of the intensity values are between 0.3 and 0.7, and for the moderate-to-high staining image 1004B, a majority of the intensity values are between 0.6 and 0.9.

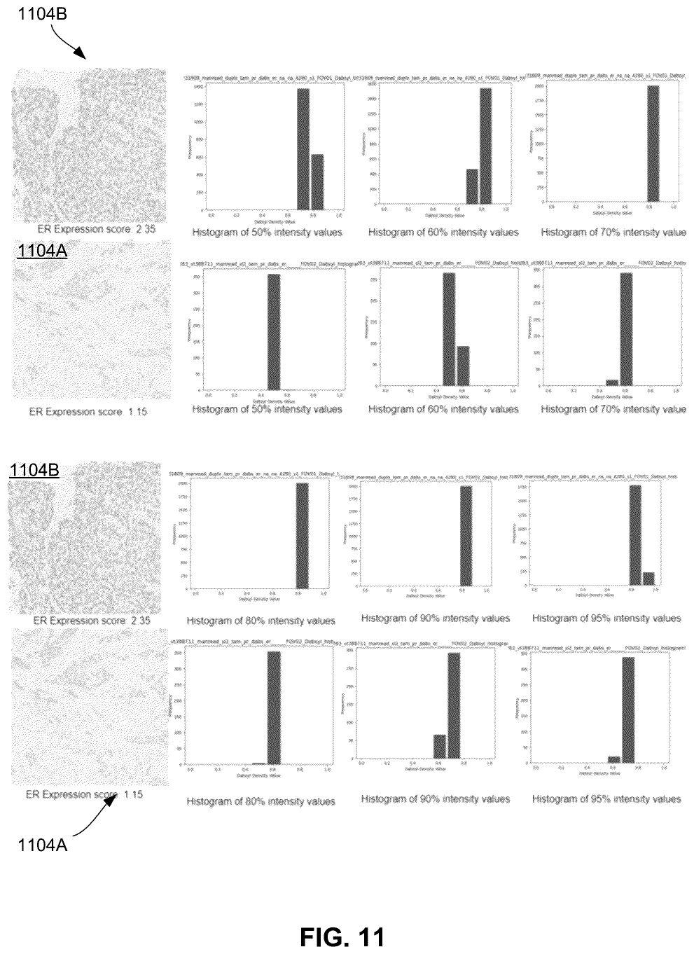

FIG. 11 illustrates example histograms corresponding to a weak staining image 1104A and a moderate-to-high staining image 1104B for an estrogen receptor protein. The histograms represent aggregated intensity values for multiple intensity percentiles for the weak staining image 1104A and the moderate-to-high staining image 1104B. The intensity percentiles include the 50% intensity percentile, the 60% intensity percentile, the 70% intensity percentile, the 80% intensity percentile, the 90% intensity percentile, and the 95% intensity percentile. For each intensity percentile, the aggregated intensity values are greater for the moderate-to-high staining image 1104B compared to the weak staining image 1104A.

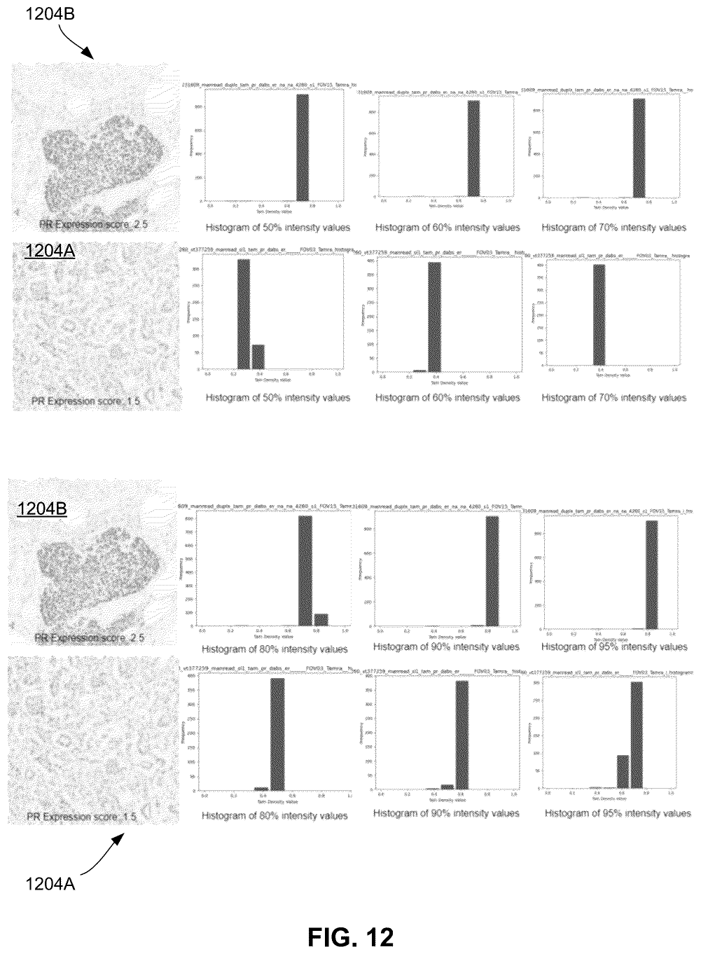

FIG. 12 illustrates example histograms corresponding to a weak staining image 1204A and a moderate-to-high staining image 1204B for a progesterone receptor protein. The histograms represent aggregated intensity values for multiple intensity percentiles for the weak staining image 1204A and the moderate-to-high staining image 1204B. The intensity percentiles include the 50% intensity percentile, the 60% intensity percentile, the 70% intensity percentile, the 80% intensity percentile, the 90% intensity percentile, and the 95% intensity percentile. Similar to FIG. 11, for each intensity percentile, the aggregated intensity values are greater for the moderate-to-high staining image 1204B compared to the weak staining image 1204A.

Returning to FIG. 1, the computing system 100 can include a label mapper 160 that maps the images 130 from the imaging system 125 containing depictions of a biomarker associated with the disease to a label indicating an expression level of the biomarker. The label may be determined based on one or more expression-level determinations for the images 130 by pathologists. For instance, one or more pathologists can provide a determination of an H-score corresponding to the expression level for a biomarker in an image, and the H-score can be used as the label. The H-score may be obtained by the formula: 3×percentage of strongly staining nuclei+2×percentage of moderately staining nuclei+percentage of weakly staining nuclei. If multiple pathologists provide an H-score, the label can be the mean or median H-score between the pathologists. The label can also include intensity values determined from the feature extraction. For instance, for the first feature extraction technique, the label can include the intensity values and corresponding intensity percentiles. For the second feature extraction method, the label can include the distribution of intensity values for each intensity percentiles. Mapping data may be stored in a mapping data store (not shown). The mapping data may identify the expression level that is mapped to each image.

In some instances, labels associated with the training dataset 150 may have been received or may be derived from data received from the remote system 155. The received data may include (for example) one or more medical records corresponding to a particular subject to which one or more of the images 130 corresponds. In some instances, images or scans that are input to one or more classifier subsystems are received from the remote system 155. For example, the remote system 155 may receive images 130 from the image generation system 105 and may then transmit the images 130 or scans (e.g., along with a subject identifier and one or more labels) to the analysis system 135.

Training controller 145 can use the mappings of the training dataset 150 to train the expression level prediction model 140. More specifically, training controller 145 can access an architecture of a model, define (fixed) hyperparameters for the model (which are parameters that influence the learning process, such as e.g. the learning rate, size/complexity of the model, etc.), and train the model such that a set of parameters are learned. More specifically, the set of parameters may be learned by identifying parameter values that are associated with a low or lowest loss, cost, or error generated by comparing predicted outputs (obtained using given parameter values) with actual outputs. In some instances, a machine-learning model can be configured to iteratively fit new models to improve estimation accuracy of an output (e.g., that includes a metric or identifier corresponding to a prediction of an expression level of a biomarker).

A machine learning (ML) execution handler 165 can use the architecture and learned parameters to process independent data and generate a result. For example, ML execution handler 165 may access a duplex IHC image not represented in the training dataset 150. In some embodiments, the duplex IHC image generated is stored in a memory device. The image may be generated using the imaging system 125. In some embodiments, the image is generated or obtained from a microscope or other instrument capable of capturing image data of a specimen-bearing microscope slide, as described herein. In some embodiments, the image is generated or obtained using a 2D scanner, such as one capable of scanning image tiles. Alternatively, the image may have been previously generated (e.g. scanned) and stored in a memory device (or, for that matter, retrieved from a server via a communication network).

In some instances, the duplex IHC image may be preprocessed in accordance with learned or identified preprocessing techniques. For example, the ML execution handler 165 may generate synthetic images depicting each of the biomarkers by applying color deconvolution to the duplex IHC image. In addition, the ML execution handler 165 may generate intensity-synthetic images by applying additional color deconvolution to each of the synthetic images. The original and/or preprocessed images (e.g., the duplex IHC image and/or each of the synthetic images) can be fed into a trained machine learning model having an architecture (e.g., U-Net) used during training and configured with learned parameters. The trained machine learning model can generate an output identifying first depictions of cells predicted to depict a first biomarker and second depictions of cells predicted to depict a second biomarker.

Once the trained machine learning model outputs the predicted biomarker depictions, the ML execution handler 165 can use the architecture and learned parameters of the expression level prediction model 140 to predict expression levels for the biomarkers. Expression-level prediction may only be performed on cells predicted to depict positive staining for at least one of the biomarkers. So, based on the output of the trained machine learning model, portions of the duplex IHC image and/or the synthetic images that depict positive staining for one or more of the biomarkers can be extracted. For example, in the intensity-synthetic image for the first biomarker, portions predicted to depict positive staining for the first biomarker can be extracted. In addition, in the intensity-synthetic image for the first biomarker, portions predicted to depict positive staining for the first biomarker can be extracted. Extracting the portions can involve defining a patch (e.g., a 5×5 patch) around each portion predicted to include a positive-staining cell. The ML execution handler 165 can then perform a feature extraction technique on the intensity-synthetic images to determine intensity values associated with intensity percentiles for each patch and for the overall image.

The original and/or preprocessed images (e.g., the duplex IHC image, each of the synthetic images, and/or each of the intensity-synthetic images) and the intensity values can be fed into the expression level prediction model 140 having an architecture (e.g., linear regression model) used during training and configured with learned parameters. The expression level prediction model 140 can generate an output identifying a predicted expression level of the first biomarker and the second biomarker.

In some instances, an image characterizer 170 identifies a predicted characterization with respect to a disease for the image based on the execution of the image processing. The execution of the expression level prediction model 140 may itself produce a result that includes the characterization, or the execution may include results that image characterizer 170 can use to determine a predicted characterization of the specimen. For example, the image characterizer 170 can perform subsequent processing that may include characterizing a presence, quantity of, and/or size of a set of tumor cells predicted to be present in the image. The subsequent processing may additionally or alternatively include characterizing the diagnosis of the disease predicted to be present in the image, classifying the disease predicted to be present in the image, and/or predicting a prognosis of the disease predicted to be present in the image. Image characterizer 170 may apply rules and/or transformations to map the predicted expression level and associated probability and/or confidence to a characterization. As an illustration, a first characterization may be assigned if a result includes a probability greater than 50% that the predicted expression level is above a threshold, and a second characterization may be otherwise assigned.

A communication interface 175 can collect results and communicate the result(s) (or a processed version thereof) to a user device (e.g., associated with a laboratory technician or care provider) or other system. For example, the results may be communicated to the remote system 155. In some instances, the communication interface 175 may generate an output that identifies the presence of, quantity of and/or size of the set of tumor cells, the diagnosis of the disease, the classification of the disease, and/or the prognosis of the disease. The output may then be presented and/or transmitted, which may facilitate a display of the output data, for example on a display of a computing device. The result may be used to determine a diagnosis, a treatment plan, or to assess an ongoing treatment for the tumor cells.

### III. Example Use Cases

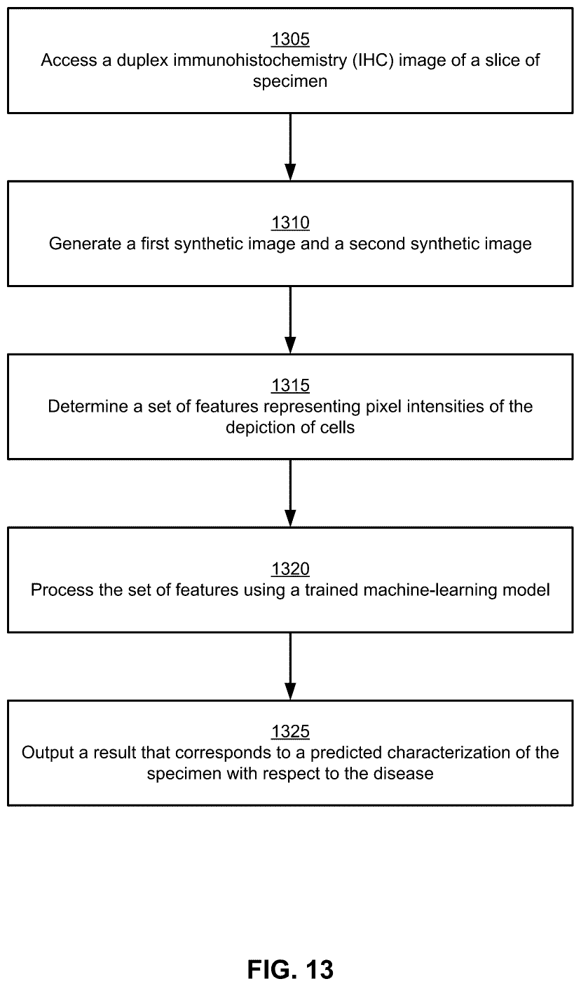

FIG. 13 illustrates an exemplary process of expression-level prediction for digital pathology images. Steps of the process may be performed by one or more systems. Other examples can include more steps, fewer steps, different steps, or a different order of steps.

At block 1305, a duplex IHC image of a slice of specimen is accessed. The duplex IHC image can include a depiction of cells associated with one or more of a first biomarker and a second biomarker corresponding to a disease. For example, for identifying breast cancer, the first biomarker can be estrogen receptor proteins and the second biomarker can be progesterone receptor proteins. The slice of specimen can include a first stain for the first biomarker and a second stain for the second biomarker. As an example, the first stain can be Dabsyl and the second stain can be Tamra.

At block 1310, a first synthetic image and a second synthetic image are generated. Color deconvolution can be applied to the duplex IHC image to generate the first synthetic image and the second synthetic image. The first synthetic image can depict the first biomarker and the second synthetic image can depict the second biomarker. Additional preprocessing may also be applied to the synthetic images. For example, additional color deconvolution may be applied the first synthetic image and the second synthetic image to generate intensity-synthetic images with grayscale pixels representing an intensity of the depiction of cells in the synthetic images. The synthetic images may also be input into a trained machine learning model that identifies depictions of cells in the first synthetic image predicted to depict the first biomarker and depictions of cells in the second synthetic image predicted to depict the second biomarker.

At block 1315, a set of features representing pixel intensities of the depiction of cells is determined. Patches can be generated that each include either a depiction of at least one cell predicted to depict the first biomarker or a depiction of at least one cell predicted to depict the second biomarker. For each cell predicted to depict positive staining for the first biomarker, a metric associated with an intensity value for the patch including the cell can be determined. For example, the metric may be an average intensity value of the pixels in the patch. The metrics for each patch in the intensity-synthetic image can then be aggregated and normalized. From the aggregated metrics, intensity values for the cells in the intensity-synthetic image predicted to depict positive staining for the first biomarker can be determined. Each intensity value can correspond to an intensity percentile from the normalized patch intensities. A similar process can be performed for each cell in the intensity-synthetic image predicted to depict positive staining for the second biomarker. An alternate feature extraction technique may involve determining, for each patch in the intensity-synthetic image predicted to depict positive staining for the first biomarker, intensity values that correspond to intensity percentiles (e.g., 50%, 60%, 70%, 80%, 90%, and 95%) for the patch. An intensity value associated with each intensity percentile can be determined and the intensity values for the intensity percentiles for each patch in the intensity-synthetic image can be aggregated. A set of metrics associated with a distribution of the aggregated intensity values for the intensity percentiles can be determined. For example, the set of metrics may be determined from histograms generated for each intensity percentile.

At block 1320, the set of features is processed using a trained machine learning model. For the first feature extraction technique, the set of features can be the intensity values that correspond to the different intensity percentiles. For the second feature extraction technique, the set of features can be the set of metrics associated with the distribution of the aggregated intensity values for the intensity percentiles.

At block 1325, a result that corresponds to a predicted characterization of the specimen with respect to the disease is output. For example, the result may be transmitted to another device (e.g., associated with a care provider) and/or displayed. The result can correspond to a predicted characterization of the specimen. The result can characterize a presence of, quantity of, and/or size of the set of tumor cells, the diagnosis of the disease, the classification of the disease, and/or the prognosis of the disease in the image.

### IV. Exemplary Results

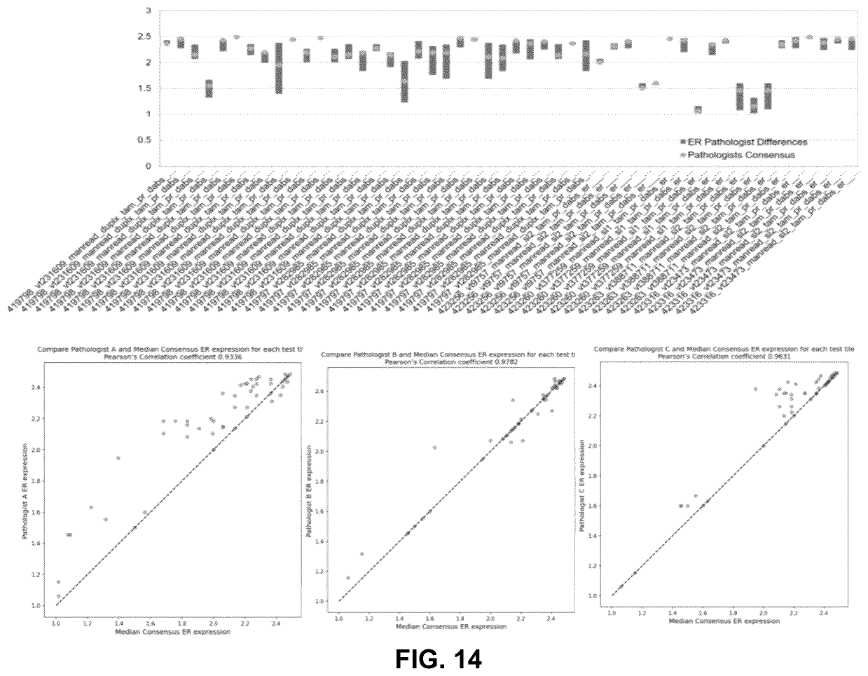

FIG. 14 illustrates example expression levels of Dabsyl estrogen receptor proteins determined by three pathologists for 50 fields of view (e.g., duplex IHC images). In scoring Dabsyl estrogen receptor proteins, moderate-to-high staining cases had high consistency across the pathologists, and low staining cases had more differences between three pathologists. The expression levels determined by each of the three pathologists were compared to the median estrogen receptor protein expression level across the pathologists for each field of view. As illustrated, there was a high consistency across the three pathologists, where each had a correlation coefficient between 0.93 and 0.98.

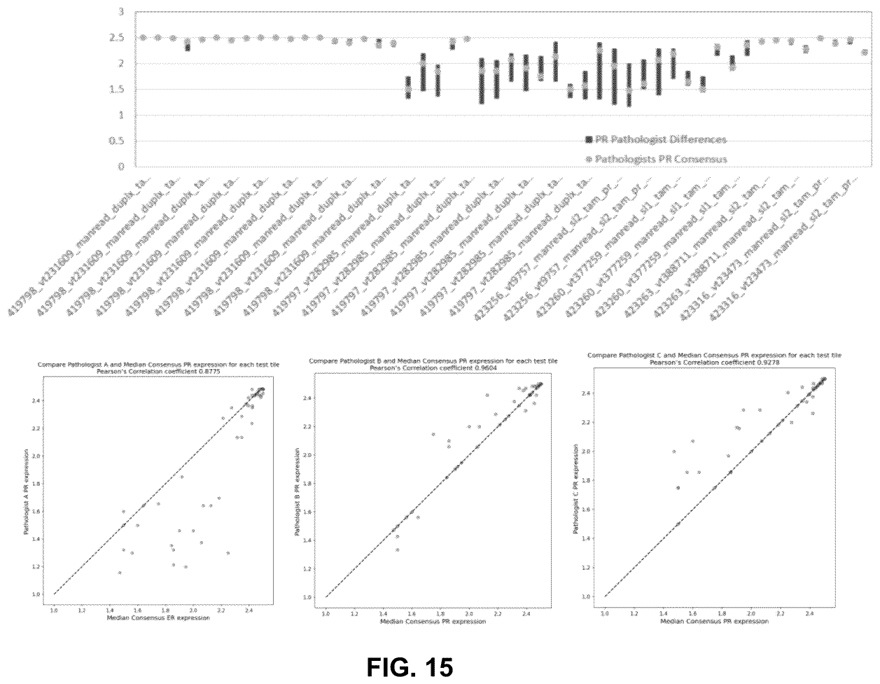

FIG. 15 illustrates example expression levels of Tamra progesterone receptor proteins determined by three pathologists for 50 fields of view (e.g., duplex IHC images). In scoring Tamra progesterone receptor proteins, moderate-to-high staining cases had high consistency across the pathologists, and low staining cases had more differences between the three pathologists. The expression levels determined by each of the three pathologists were compared to the median progesterone receptor protein expression level across the pathologists for each field of view. As illustrated, there was a high consistency across the three pathologists, where each had a correlation coefficient between 0.88 and 0.96.

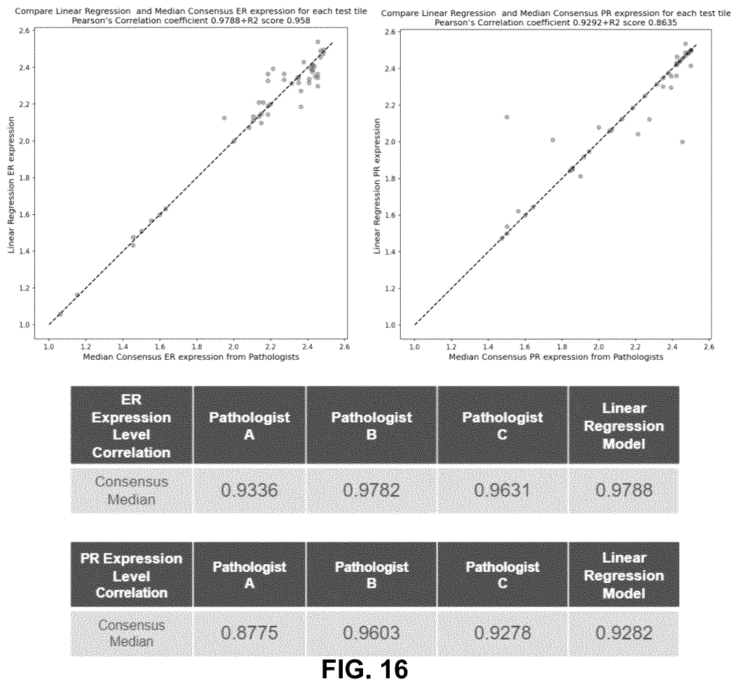

FIG. 16 illustrates example performances of using a machine learning model to predict expression level. Intensity values were extracted using the second feature extraction technique described herein above. The trained machine learning model (e.g., the expression level prediction model 140 in FIG. 1) achieved a high degree of consistency with respect to the expression levels determined by the pathologists in predicting the expression level compared with the median estrogen receptor expression level determined by the pathologists and the median progesterone receptor expression level determined by the pathologists. Compared with the median consensus expression levels, the trained machine learning model predicted the expression level and achieved higher consistency than the scoring performed by the pathologists. The correlation was 0.9788 for the prediction of the estrogen receptor protein expression level by the trained machine learning model compared to the median consensus expression level and 0.9292 for the prediction of the progesterone receptor protein expression level by the trained machine learning model compared to the median consensus expression level. The determination of prediction R square was 0.958 and 0.8635, respectively. The table additionally shows the correlation between the three pathologists and the trained machine learning model. In scoring Dabysl estrogen receptor protein expression level, the trained machine learning model achieved higher correlation to the median consensus than any of the pathologists. In addition, in scoring Tamra progesterone receptor protein expression level, the trained machine learning model outperformed two of the pathologists with respect to the correlation to the median consensus. As a result, the trained machine learning model may produce more consistently accurate expression-level predictions than pathologists that can facilitate more accurate characterizations of diseases.

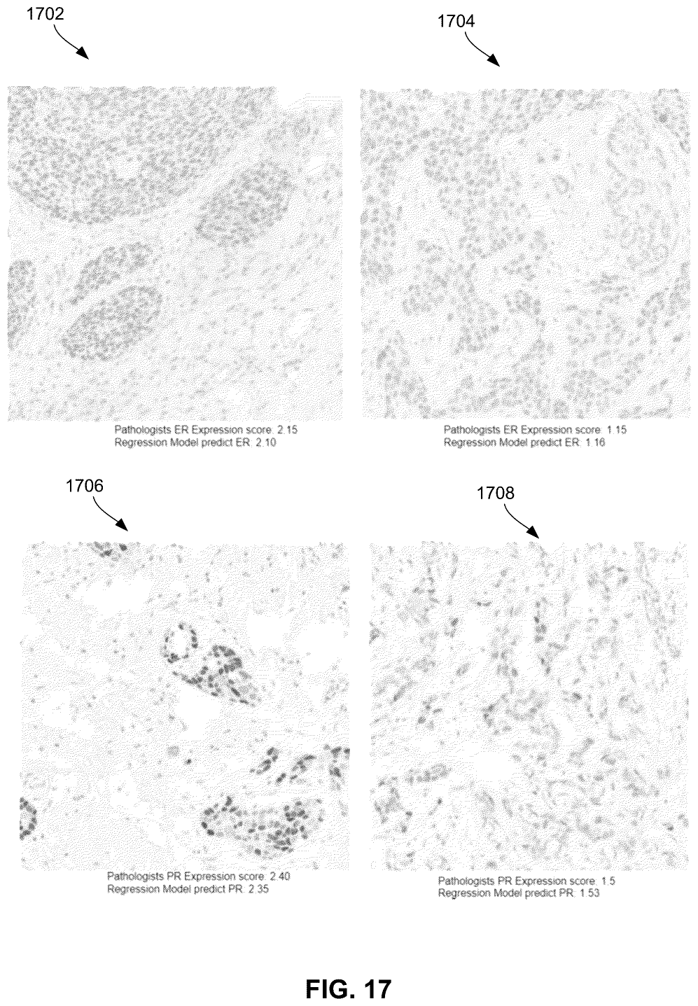

FIG. 17 illustrates exemplary expression-level scores generated by pathologists and a trained machine learning model. For image 1702, pathologists determined an expression level for estrogen receptor proteins of 2.15, and the trained machine learning model determined an expression level for estrogen receptor proteins of 2.10. For image 1704, pathologists determined an expression level for estrogen receptor proteins of 1.15, and the trained machine learning model determined an expression level for estrogen receptor proteins of 1.16. For image 1706, pathologists determined an expression level for progesterone receptor proteins of 2.40, and the trained machine learning model determined an expression level for progesterone receptor proteins of 2.35. For image 1708, pathologists determined an expression level for progesterone receptor proteins of 1.50, and the trained machine learning model determined an expression level for progesterone receptor proteins of 1.53. In each case, the prediction by the trained machine learning model was within 0.05 of the score determined by the pathologists, further illustrating the accuracy of the trained machine learning model in predicting expression levels of biomarkers in digital pathology images.

### V. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing a duplex immunohistochemistry (IHC) image of a slice of specimen, wherein the duplex IHC image comprises a depiction of cells associated with one or more of a first biomarker and a second biomarker corresponding to a disease;
generating, from the duplex IHC image, a first synthetic image depicting the first biomarker and a second synthetic image depicting the second biomarker;
determining, for each of the first synthetic image and the second synthetic image, a set of features representing pixel intensities of the depiction of cells in the first synthetic image and the second synthetic image;
processing the set of features using a trained machine learning model, wherein an output of the processing corresponds to a predicted expression level of the first biomarker and the second biomarker; and
outputting a result that corresponds to a predicted characterization of the specimen with respect to the disease based on the output of the processing.

2. The computer-implemented method of claim 1, further comprising, prior to determining the set of features:
preprocessing the first synthetic image and the second synthetic image by applying color deconvolution to the first synthetic image and the second synthetic image.

3. The computer-implemented method of claim 1, further comprising, prior to determining the set of features:
processing the first synthetic image and the second synthetic image using another trained machine learning model, wherein another output of the processing identifies first depictions of cells of the first synthetic image predicted to depict the first biomarker and second depictions of cells of the second synthetic image predicted to depict the second biomarker.

4. The computer-implemented method of claim 3, wherein determining the set of features for the first synthetic image comprises:
determining, for each cell in the first depictions of cells, a first metric associated with an intensity value for a patch of the cell including the cell;
aggregating, for the first depictions of cells, the first metric for each patch; and
determining, based on the aggregation, a plurality of intensity values for the first depictions of cells, wherein each intensity value of the plurality of intensity values corresponds to an intensity percentile, and wherein the plurality of intensity values correspond to the set of features.

5. The computer-implemented method of claim 3, wherein determining the set of features for the first synthetic image comprises:
determining, for each cell in the first depictions of cells, a first plurality of intensity values corresponding to intensity percentiles for a patch including the cell;
aggregating, for the first depictions of cells, the first plurality of intensity values for each patch to generate a second plurality of intensity values; and
determining a set of metrics associated with a distribution of the second plurality of intensity values, wherein the set of metrics correspond to the set of features.

6. The computer-implemented method of claim 1, wherein the first biomarker comprises estrogen receptor proteins and the second biomarker comprises progesterone receptor proteins.

7. The method of claim 1, wherein the trained machine learning model comprises a linear regression model.

8. The computer-implemented method of claim 1, wherein a sample slice of the specimen comprises a first stain for the first biomarker and a second stain for the second biomarker.

9. The computer-implemented method of claim 8, wherein the first stain comprises tetramethylrhodamine and the second stain comprises 4-Dimethylaminoazobenzene-4′-sulfonyl.

10. The computer-implemented method of claim 1, further comprising performing subsequent processing to generate the result of the predicted characterization of the specimen, wherein performing the subsequent processing includes detecting depictions of a set of tumor cells, and wherein the result characterizes a presence of, quantity of and/or size of the set of tumor cells.

11. A system comprising:
one or more data processors; and
a non-transitory computer readable storage medium containing instructions which, when executed on the one or more data processors, cause the one or more data processors to perform operations comprising:
accessing a duplex immunohistochemistry (IHC) image of a slice of specimen, wherein the duplex IHC image comprises a depiction of cells associated with one or more of a first biomarker and a second biomarker corresponding to a disease;
generating, from the duplex IHC image, a first synthetic image depicting the first biomarker and a second synthetic image depicting the second biomarker;
determining, for each of the first synthetic image and the second synthetic image, a set of features representing pixel intensities of the depiction of cells in the first synthetic image and the second synthetic image;
processing the set of features using a trained machine learning model, wherein an output of the processing corresponds to a predicted expression level of the first biomarker and the second biomarker; and
outputting a result that corresponds to a predicted characterization of the specimen with respect to the disease based on the output of the processing.

12. The system of claim 11, wherein the non-transitory computer readable medium further contains instructions which, when executed on the one or more data processors, cause the one or more data processors to perform operations comprising, prior to determining the set of features:
preprocessing the first synthetic image and the second synthetic image by applying color deconvolution to the first synthetic image and the second synthetic image.

13. The system of claim 11, wherein the non-transitory computer readable medium further contains instructions which, when executed on the one or more data processors, cause the one or more data processors to perform operations comprising, prior to determining the set of features:
processing the first synthetic image and the second synthetic image using another trained machine learning model, wherein another output of the processing identifies first depictions of cells of the first synthetic image predicted to depict the first biomarker and second depictions of cells of the second synthetic image predicted to depict the second biomarker.

14. The system of claim 13, wherein determining the set of features for the first synthetic image comprises:
determining, for each cell in the first depictions of cells, a first metric associated with an intensity value for a patch of the cell including the cell;
aggregating, for the first depictions of cells, the first metric for each patch; and
determining, based on the aggregation, a plurality of intensity values for the first depictions of cells, wherein each intensity value of the plurality of intensity values corresponds to an intensity percentile, and wherein the plurality of intensity values correspond to the set of features.

15. The system of claim 13, wherein determining the set of features for the first synthetic image comprises:
determining, for each cell in the first depictions of cells, a first plurality of intensity values corresponding to intensity percentiles for a patch including the cell;
aggregating, for the first depictions of cells, the first plurality of intensity values for each patch to generate a second plurality of intensity values; and
determining a set of metrics associated with a distribution of the second plurality of intensity values, wherein the set of metrics correspond to the set of features.

16. The system of claim 13, wherein the first biomarker comprises estrogen receptor proteins and the second biomarker comprises progesterone receptor proteins.

17. The system of claim 11, wherein the trained machine learning model comprises a linear regression model.

18. The system of claim 11, wherein a sample slice of the specimen comprises a first stain for the first biomarker and a second stain for the second biomarker.

19. The system of claim 18, wherein the first stain comprises tetramethylrhodamine and the second stain comprises 4-Dimethylaminoazobenzene-4′-sulfonyl.

20. The system of claim 11, wherein the non-transitory computer readable medium further contains instructions which, when executed on the one or more data processors, cause the one or more data processors to perform operations comprising:
performing subsequent processing to generate the result of the predicted characterization of the specimen, wherein performing the subsequent processing includes detecting depictions of a set of tumor cells, and wherein the result characterizes a presence of, quantity of and/or size of the set of tumor cells.

21. A computer-program product tangibly embodied in a non-transitory machine-readable storage medium, including instructions configured to cause one or more data processors to perform operations comprising:
accessing a duplex immunohistochemistry (IHC) image of a slice of specimen, wherein the duplex IHC image comprises a depiction of cells associated with one or more of a first biomarker and a second biomarker corresponding to a disease;
generating, from the duplex IHC image, a first synthetic image depicting the first biomarker and a second synthetic image depicting the second biomarker;
determining, for each of the first synthetic image and the second synthetic image, a set of features representing pixel intensities of the depiction of cells in the first synthetic image and the second synthetic image;
processing the set of features using a trained machine learning model, wherein an output of the processing corresponds to a predicted expression level of the first biomarker and the second biomarker; and
outputting a result that corresponds to a predicted characterization of the specimen with respect to the disease based on the output of the processing.
